(19) United States
(12) Patent Application Publication
(10) Pub. No.: US 2024/0381809 A1
(43) Pub. Date: Nov. 21, 2024

(54) Material Spreader

(71) Applicant: Tyler William Aalbers, Dunnville (CA)

(72) Inventor: Tyler William Aalbers, Dunnville (CA)

(21) Appl. No.: 18/197,888

(22) Filed: May 16, 2023

(51) Int. Cl. A01C 17/00; A01C 15/00

(52) U.S. Cl. CPC A01C 17/006; A01C 15/006

(57) ABSTRACT

A material spreader is provided. The material spreader includes a hopper for storing material to be a spread which feeds to a rotary spreader assembly. The rotary spreader assembly includes an impeller that rotates about a hub which is secured to an impeller shaft. The impeller includes two or more blades extending radially from the impeller shaft which spin to cause the material to be discharged from the assembly through a chute. The spreader includes a base with a pair of wheels linked via a wheel axle that allows for manual movement. A wheel axle gear set is mounted to the wheel axle such that the wheel axle and wheels mesh with an impeller gear set mounted on the impeller shaft. When the wheels rotate, the movement causes the impeller shaft to rotate and discharges the material through the chute.

### BACKGROUND OF THE INVENTION

The present invention relates to a material spreader and, more particularly, to a spreader capable of being pushed or pulled, which drives the discharge of the stored material. The present invention specifically provides a material spreader that houses material within a hopper and discharges the material in a predictable pattern through a chute, wherein the material is discharged via a rotary spreader assembly driving by the wheels of the spreader. Additionally, the spreader provides a variable flow gate that controls the amount of material that enters the rotary spreader assembly and a clutch for controlling the actuation of the rotary spreader assembly.

The application of various materials, such as lime, salt, and other agents, to treat surfaces has been a long-standing practice in many industries. However, the traditional method of spreading these materials by manual labor can be time-consuming and often results in an uneven distribution of the material, leading to ineffective surface treatment. In the agricultural industry, lime, also known as calcium carbonate, is widely used to prevent the build-up of toxic odors from livestock waste, particularly in barns and stalls where ammonia is produced from the urea in the waste. However, the manual distribution of lime can be difficult and time-consuming, resulting in inconsistent treatment and reduced efficacy.

Numerous material spreader systems are known, but many of them require a separate power source to operate either the drive system or the spreader systems, which can be inefficient and costly. For example, a spreader may look to discharge lime, salt, or other material agents over an area to the front and sides of the spreader for maximal coverall. In this application, the user is often forced to discharge the material to unwanted areas for a variety of reasons. For example, this application may cause an excess of material to be used in certain locations, as well as applying material in locations that are not warranted. Additionally, these systems may be challenging to control, leading to inconsistent material spread and waste in unwanted areas. This is particularly problematic in applications such as dairy barn stalls, where minimal dust and precise application are critical for reducing bacteria and ensuring animal health.

In light of the deficiencies in current lime spreading systems, there exists a need for a lime spreader that addresses the issues of manual labor and inefficient, inconsistent distribution. The present invention solves these problems by providing a lime spreader system that efficiently and effectively distributes the material across surfaces, particularly in agricultural settings such as barns and stalls. The system uses a rotating impeller driven by a shaft linked via gears to the wheel axle, enabling the impeller to rotate as the wheels turn. The system discharges the lime through a chute on a single side of the device, providing precise application and reducing waste. Furthermore, the system includes a stand that supports the spreader in an upright position, allowing for easy loading and storage. By utilizing a rotating impeller driven by a shaft linked via gears to the wheel axle, the system enables the impeller to rotate as the wheels turn, providing precise and even distribution of the material. This results in reduced waste, improved treatment efficacy, and decreased labor time, providing significant benefits for farmers and other users.

In light of the devices disclosed in the known art, it is submitted that the present invention substantially diverges in design elements and methods from the known art and consequently it is clear that there is a need in the art for material spreaders. In this regard the instant invention substantially fulfills these needs.

### SUMMARY OF THE INVENTION

In view of the foregoing disadvantages inherent in the known types of material spreaders now present in the known art, the present invention provides a new material spreader that controls the discharge of agents via a system that is easily controllable as the material spreader is in motion.

One objective of the present invention is to provide a material spreader that is precise and efficient, allowing for even distribution of lime or other material across surfaces. The spreader uses a hopper to store the material variable flow gate configured to control the flow of material into the rotary assembly.

Another objective of the present invention is to simplify the application of lime and other agents by having a clutch that activates and deactivates the discharge of material.

It is an objective of the present invention to provide a material spreader that reduces waste and improves treatment efficacy, resulting in cost savings for users.

It is an objective of the present invention to provide a material spreader that offers minimal dust during application, improving safety and air quality for users.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the material spreader.

FIG. 2 shows a perspective view of an embodiment of the impeller of the rotary spreader assembly of the material spreader with the hopper removed.

FIG. 3 shows a perspective view of an embodiment of the agitator of the material spreader when the container is removed.

FIG. 4 shows a close-up view of an embodiment of the wheel and drive assembly of the material spreader.

FIG. 5 shows an exploded view of an embodiment of the hopper assembly and handle of the material spreader.

### DETAILED DESCRIPTION OF THE INVENTION

Reference is made herein to the attached drawings. For the purpose of presenting a brief and clear description of the present invention, the preferred embodiment will be discussed as used for spreading material, such as lime, in an agricultural setting. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

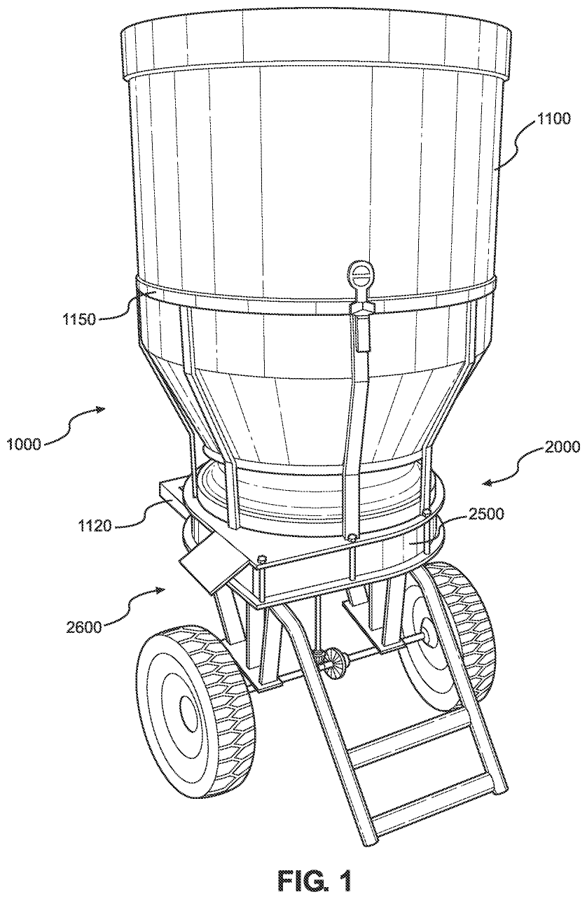

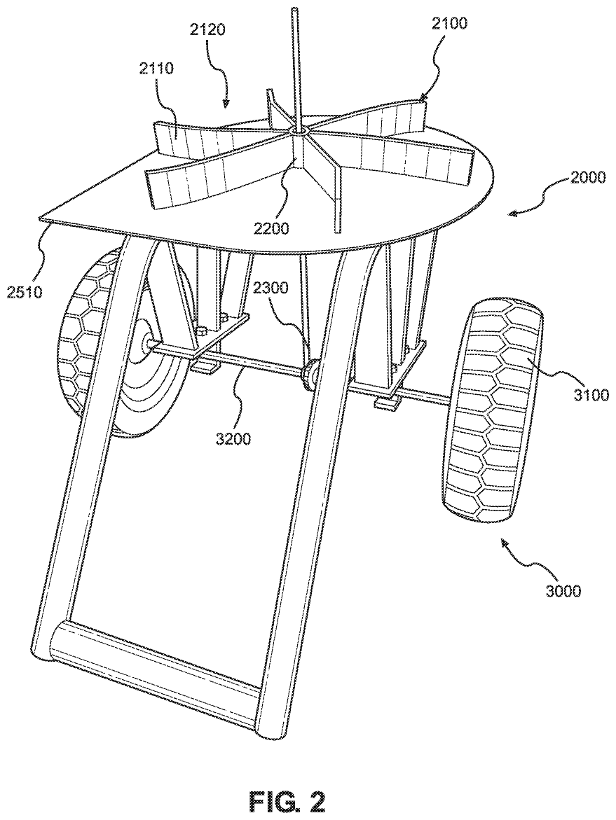

Referring now to FIGS. 1 and 2, there is shown a perspective view of an embodiment of the material spreader and a perspective view of an embodiment of the impeller of the rotary spreader assembly of the material spreader with the hopper removed, respectively. The material spreader 1000 provides for efficient and even distribution of agricultural materials, such as lime or any other suitable spreading material, onto surfaces. In the shown embodiment, the material spreader 1000 comprises a hopper 1100 that sits atop a lower assembly that allows for the movement of the material spreader 1000 and the distribution of material contained within the hopper 1100. The hopper 1100 is configured to store and feed the material to a rotary spreader assembly 2000. In the shown embodiment, the hopper 1100 comprises a funnel-shaped container 1110, with a wider opening at the top to receive the material and a narrower outlet at the bottom to allow the material to be funneled to the bottom for efficient and maximum discharged material. This shape helps to ensure a smooth and consistent flow of material from the hopper to the impeller, minimizing the risk of blockages or uneven distribution. In other embodiments, the hopper 1100 may have a variety of shapes for storing the material therein.

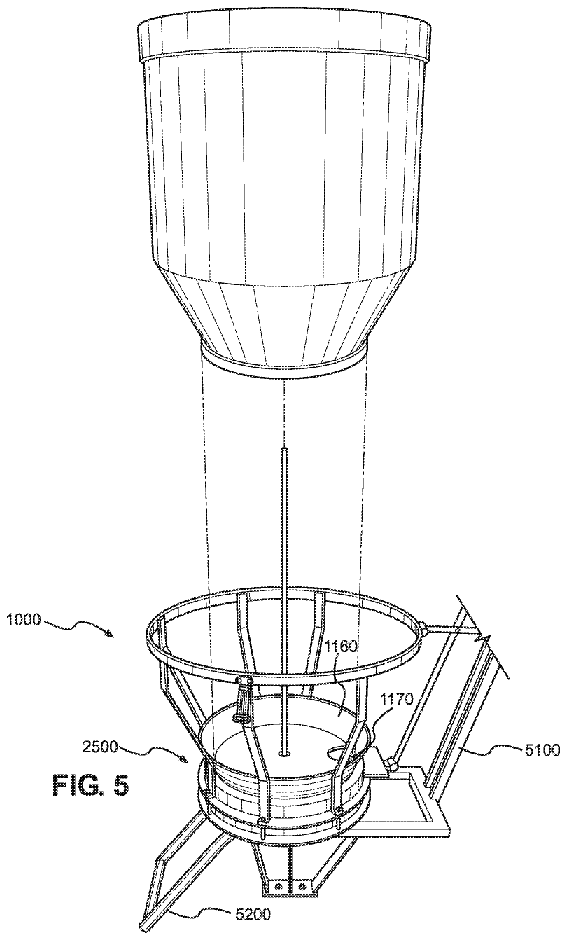

In the shown embodiment, the hopper 1100 is secured to the rotary spreader assembly 2000 via a frame 1150, wherein the frame 1150 includes a plurality of members that extend from the rotary spreader assembly 2000 and encircle the hopper 1100. The frame 1150 is adapted to receive the removable hopper 1100, wherein the hopper 1100 comprises an open lower end that is seated over a receiver or lower portion 1160 (as shown in FIG. 5). In one embodiment, the hopper 1100 includes an open channel for delivering the material to the rotary spreader assembly 2000.

Specifically referring to FIG. 2, the rotary spreader assembly 2000 comprises an impeller 2100 that rotates about a hub 2200 which is secured to an impeller shaft 2300. The impeller 2100 includes two or more blades 2110 that extend radially from the impeller shaft 2300. The blades 2110 are spaced apart and form compartments 2120 between the adjacent blades. These compartments 2120 are sized to receive material from the hopper 1100 via the open channel.

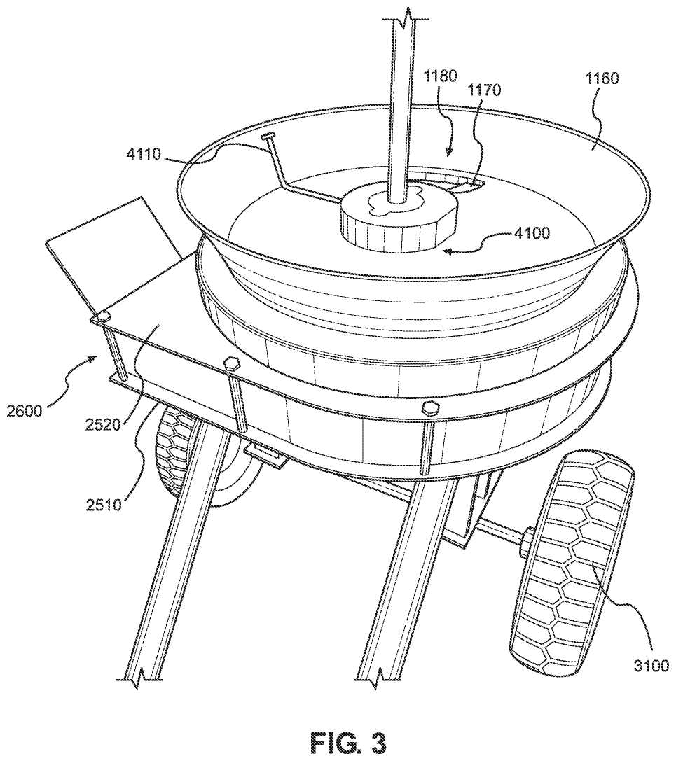

In the shown embodiment, the impeller 2100 is positioned within a housing 2500, wherein the housing 2500 is formed from a lower plate 2510 and an upper plate 2520 (as shown in FIG. 3). The lower plate 2510 and upper plate 2520 are generally circular in shape, having a portion that extends tangentially which forms the chute 2600. The chute 2600 is disposed on a first side 1120 of the housing 2500 for centrifugally discharging the material driven by the impeller 2100.

In the shown embodiment, a base 3000 is positioned below and supports the rotary spreader assembly 2000. The base 3000 comprises a pair of wheels 3100 connected via a wheel axle 3200. A wheel axle gear set 3210 is mounted on the wheel axle 3200 and designed to engage with an impeller gear set 2310 mounted on the impeller shaft 2300. As a result, the rotation of the wheels 3100 causes the impeller shaft 2300 to rotate, thereby driving the impeller 2100 and enabling the uniform distribution of material through the chute 2600.

Referring now to FIG. 3, there is shown a perspective view of an embodiment of the agitator of the material spreader when the container is removed. In the shown embodiment, the receiver 1160 is positioned over the upper plate 2520 of the housing 2500. The hopper comprises a container configured to receive the material and the receiver is adapted to maintain the hopper housing in an upright position. In the illustrated embodiment, the container is separable from the lower portion of the hopper. The receiver 1160 is sized to receive a funnel-shaped container having a wider opening at the top to receive the material and a narrower outlet at the bottom to allow the material to be discharged. The receiver 1160 includes a variable flow gate 1170 which is configured to control the flow of material into the rotary assembly 2500. The variable flow gate 1170 is adapted to transition between an open positioned and a closed position. In an open position, the variable flow gate 1170 allows for the material positioned within the hopper to flow into the rotary assembly 2500. In the closed position, the variable flow gate 1170 blocks the flow of material into the rotary assembly via the channel 1180. In some embodiments, the variable flow gate 1170 is controlled manually, through a switch or lever. In alternative embodiments, the variable flow gate 1170 is operably connected to a motor for automatic control.

In the shown embodiment, an agitator 4100 is positioned within the receiver 1160. The agitator 4100 is adapted to agitate the material in the hopper and to direct the material into the channel 1180. The agitator 4100 comprises a rod 4110 that extends along a bottom and along a sidewall of the receiver 1160 and configured to extend within the hopper. The rod 4110 is driven by the impeller shaft and rotates thereabout. As the agitator rod 4110 rotates, the agitator 4100 forces material to fall through the open variable flow gate 1170 and channel 1180.

In the shown embodiment, the housing 2500 is formed from a lower and an upper plate 2510, 2520, with a sidewall extending therebetween that encloses the impeller within the housing 2500. The housing 2500 is generally shaped as a disk, wherein the chute 2600 extends tangentially outward from the disk-shaped housing 2500. In this way, as the blade of the impeller causes the material to discharge via centrifugal force, the direction the material travels is aligned with the chute 2600.

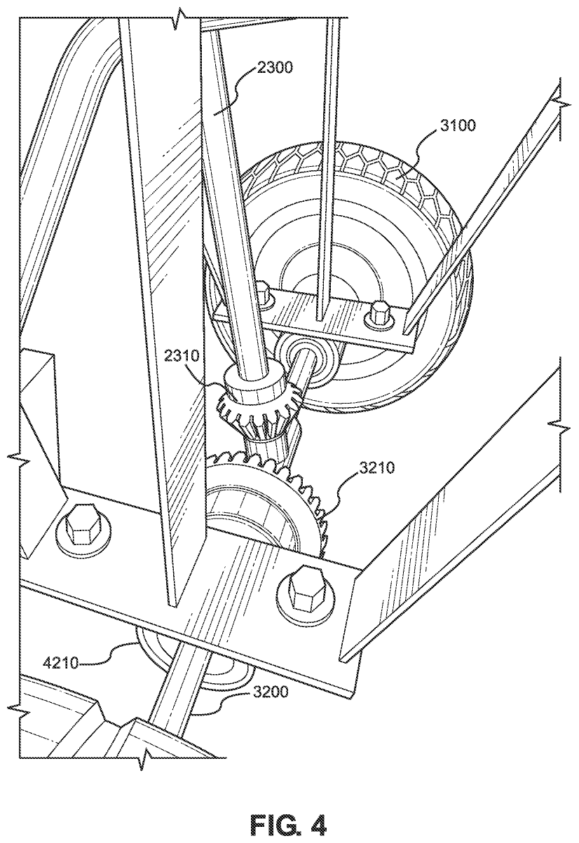

Referring now to FIG. 4, there is shown a close-up view of an embodiment of the wheel and drive assembly of the material spreader. In the shown embodiment, the impeller shaft 2300 extends from the housing 2500 towards the wheel axle 3200. The impeller gear set 2310 is positioned at an end of the impeller shaft 2300 and is adapted to mesh with the wheel axle gear set 3210. In the current configuration, the rotation of the wheels 3100 transmits the force to the impeller.

In one embodiment, a clutch handle is operably connected to the wheel axle gear set 3210, wherein the clutch handle is operably connected to a clutch 4210 that is configured to engage and disengage the wheel axle gear set 3210 from the wheel axle 3200. In one embodiment, the clutch 4210 engages and disengages the impeller gear set 2310 from the impeller 2100. In alternative embodiments, the clutch 4210 is operably connected to the impeller 2100, the wheels 3100, or other component that allows for the disengagement of the impeller from the rotation of the wheels 3100. In this way, the clutch 4210 provides for the movement of the spreader 1000 without necessitating the rotation of the impeller. In one embodiment, the clutch handle is operably connected to the variable flow gate to control the position of a variable flow gate, wherein the variable flow gate is positioned adjacent to the channel. The clutch handle may be positioned at the handle of the spreader 1000.

Referring now to FIG. 5, there is shown an exploded view of an embodiment of the hopper assembly and handle of the material spreader. In the shown embodiment, the spreader 1000 includes a handle 5100 that extends from the lower portion 1160 which provides a user with an ability to move the spreader as desired. At a side opposite the handle, a stand 5200 extends from the receiver 1160 which is adapted to form an additional support for the material spreader 1000. In this way, the wheels and the stand 5200 keep the spreader 1000 in an upright position without needing a user to support the material spreader 1000. Additionally, the position of the stand 5200 allows the user to pivot the material spreader 1000 via the wheels to lift the stand 5200 from contacting the ground. In alternative embodiments, the handle 5100 and the stand 5200 are positioned on the sides or on the same side as each other. In other embodiments, the stand 5200 is retractable and/or removable from the material spreader 1000. In yet other embodiments, the handle 5100 and the stand 5200 extend from other portions of the device.

To use the material spreader 1000, the container 1110 is secured onto the lower portion 1160, and the desired material, such as lime, is either loaded into the hopper or is already in the hopper. The material spreader 1000 is moved into position and the variable flow gate 1170 on the hopper is then opened. The clutch 4210 is then released to selectively engage the impeller 2100, which causes the lime to flow into the impeller housing 2500 when the wheels 3100 are moved. As the spreader 1000 is moved, the lime is discharged through the chute 2600. The agitator 4100 is responsible for consistently feeding the lime from the hopper 1100 into the impeller housing 2500. The variable flow gate 1170 is then adjusted to achieve the desired flow rate for the material. When a desired amount of lime has been spread, the clutch 4210 is disengaged to allow for the movement of the spreader without the discharge of lime.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A material spreader, comprising:
a hopper configured to store a material to be spread;
wherein the hopper includes an open channel for delivering the material to a rotary spreader assembly,
the rotary spreader assembly comprising:
an impeller that rotates about a hub which is secured to an impeller shaft, wherein the impeller includes two or more blades extending radially from the impeller shaft;
wherein the blades are spaced apart forming compartments between adjacent blades to receive material from the channel;
wherein the impeller is positioned within a housing;
a chute disposed on a first side of the housing for centrifugally discharging the material driven by the impeller;
a base with a pair of wheels linked via a wheel axle;
a wheel axle gear set mounted to the wheel axle adapted to meshes with an impeller gear set mounted on the impeller shaft, wherein rotation of the wheels causes the impeller shaft to rotate.

2. The material spreader of claim 1, further comprising a clutch handle operably connected to the wheel axle gear set, wherein the clutch handle is operably connected to a clutch.

3. The material spreader of claim 2, wherein the clutch is configured to engage and disengage the impeller gear set from the impeller.

4. The material spreader of claim 2, wherein the clutch handle is operably connected to the variable flow gate to control the position of a variable flow gate, the variable flow gate positioned adjacent the channel.

5. The material spreader of claim 1, wherein the hopper comprises a frame adapted to receive a removable container, wherein the container comprises an open lower end that is seated over a receiver, wherein the open channel is formed within the container, such that an upper end and a lower end of the container are open.

6. The material spreader of claim 1, wherein a variable flow gate is positioned over the open lower end of the hopper and is configured to control the flow of material into the rotary assembly via transitioned between an open positioned and a closed position.

7. The material spreader of claim 1, wherein the frame comprises a locking member for securing the removable container therewith.

8. The material spreader of claim 7, wherein the container includes a taper at a lower end thereof, such that the lower end is narrower than an opposing upper end thereof.

9. The material spreader of claim 1, further comprising an agitator for agitating the material in the hopper to direct the material into the channel, wherein the agitator is driven by the impeller shaft and rotates thereabout.

10. The material spreader of claim 9, wherein the agitator is positioned within a receiver.

11. The material spreader of claim 9, wherein the agitator comprises rod that extends along a bottom of the hopper and extends upward along a sidewall of the hopper.

12. The material spreader of claim 1, wherein the housing is formed from an upper and lower plate, with a sidewall extending therebetween that closes the impeller within the housing.

13. The material spreader of claim 12, wherein the housing is formed from a lower plate and a lower side of the hopper.

14. The material spreader of claim 1, wherein the base further comprises a stand extending from a front of the material spreader that supports the spreader in an upright position.

15. The material spreader of claim 14, wherein the stand is engaged when the spreader is rotated forward to cooperatively utilize the pair of wheels as a second support.

16. The material spreader of claim 1, wherein the material spreader comprises a handle for manually driving the material spreader.

17. The material spreader of claim 1, wherein the chute is only disposed on the first side configured to spread the material on a single side of the material spreader when in motion.
